(19) United States
(12) Patent Application Publication
(10) Pub. No.: US 2007/0159446 A1
(43) Pub. Date: Jul. 12, 2007

(54) LCD backlight lifetime indicator

(76) Inventors: Erin L. Taylor, Pflugerville, TX (US); Eugen Munteanu, Austin, TX (US)

Correspondence Address: HAMILTON & TERRILE, LLP, P.O. BOX 203518, AUSTIN, TX, 78720, US

(21) Appl. No.: 11/328,654

(22) Filed: Jan. 10, 2006

(51) Int. Cl. G09G 3/36

(52) U.S. Cl. 345/102

(57) ABSTRACT

An improved apparatus and method for measuring and reporting the amount of time an LCD panel backlight has been in operation. Various embodiments of the invention can provide backlight usage data that can be correlated with vendor-specified lifetime curves to determine its remaining life. In various embodiments these correlations can be used by service personnel when diagnosing defective LCD panels to determine whether the backlight should be replaced, thereby reducing the number of follow-on service requests.

### BACKGROUND OF THE INVENTION

1. Field of the Invention

The present invention relates in general to the field of information handling system displays, and more particularly to a system and method for determining the remaining life of LCD panel backlights.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems configured as portable units have grown in popularity among users over the past several years. Portable information handling systems generally integrate in a single housing a display, internal power source and processing components, such as the CPU and hard disk drive, so that a user can carry the portable system from place to place while the system is operating. As processing components have decreased in size and increased in performance, portable information handling systems are often able to pack processing capabilities into a relatively small housing that are comparable to the capabilities available from desktop systems. Generally, the most practical display solution for portable systems both in terms of size and power consumption are liquid crystal display (LCD) panels. LCD panels have a backlight, such as an electroluminescent panel (ELP), one or more light emitting diodes (LEDs), or a cold cathode florescent lamp (CCFL), that illuminates the display through a panel of pixels. An image is generated by altering the light-absorbing characteristics of the pixels so that backlight passing through a pixel has a desired color.

The brightness of the image on the LCD panel can diminish as a backlight's luminance level decreases over its lifetime, which is defined as the time it takes for a backlight's brightness level to drop to 50% of its initial value. Backlight lifetimes currently range from 3,000 to 5,000 hours for ELPs, 10,000 to 20,000 hours for CCFLs, and as much as 50,000 hours for LEDs. Backlight lifetime can be a limiting factor to an LCD's mean time before failure (MTBF) and can also result in LCD panels being returned for service due to backlight failures causing low image brightness or lack of a visible image. Labor costs to repair portable LCD panels, combined with the cost of replacement parts, can be expensive and similar repairs of LCD computer monitors and TVs can be even more costly.

Currently, LCD panel luminance level testing is typically performed through visual inspection or optical measurement methods known to those of skill in the art. Regardless of the current testing method, there is no way of determining how long the backlight has been in operation, nor how many hours of its projected lifetime remain. This can result in a serviced panel that passes one or more inspection tests being returned to a customer, even though the backlight could be nearing the end of its life. Return of a marginal backlight to the customer can result in a need for follow-on service, requiring replacement of the backlight, and incurring additional warranty costs and/or customer expense and inconvenience.

Current approaches to addressing this issue include “power-on” counters that record the amount of time that power is consumed by a Flat Panel Monitor (FPM). These counters are typically implemented in the flat panel monitor's image scaler/microprocessor, which is used to convert the resolution of a video signal to a resolution that is higher or lower. However, if the LCD panel fails and is removed from the monitor, all recorded backlight usage data will be lost as the counter is not integrated into the LCD panel itself. This problem extends to all LCD displays including desktop monitors and TVs.

Each LCD panel backlight technology has its own operational lifetime characteristics. For example, CCFLs are a mature technology and while it is unlikely that significant advances will be made in increasing lamp lifetimes, they are anticipated to be in the mainstream market for the foreseeable future. ELPs have limited lifetimes and brightness consistency issues. Conversely, while LEDs are currently limited to small displays, they have long lifetimes and offer precise control of intensity levels. In view of the foregoing, and regardless of the backlight technology implemented, there is a need for a system and apparatus to determine the remaining life of a backlight by measuring and reporting the amount of time it has been in use.

### SUMMARY OF THE INVENTION

The present invention provides an improved apparatus and method for measuring and reporting the amount of time an LCD panel backlight has been in operation. Various embodiments of the invention can provide backlight usage data that can be correlated with vendor-specified lifetime curves to determine its remaining life. These correlations can be used by service personnel when diagnosing defective LCD panels to determine whether the backlight should be replaced, regardless of its current output brightness, thereby reducing the number of follow-on service requests.

For example, a failed LCD panel is returned for warranty service, and through use of the invention, it is determined that its CCFL backlight has been “on” over 10,000 hours. If the CCFL's typical, vendor-specified lifetime is 15,000 hours, it may be more cost effective to replace it as the CCFL backlight may reach the end of its life and fail before the warranty period expires. If the CCFL backlight is not replaced and fails at a later date, the LCD panel may be returned for follow-on service, which would incur additional service costs, increase the cost of the warranty, and further inconvenience the customer.

In some embodiments, the present invention is implemented on a power inverter coupled to a CCFL backlight, which has the additional benefit of not requiring a system interface to maintain CCFL backlight usage information. Since LCD panels, CCFL backlights and inverters typically remain coupled together as an assembly, such implementations could also ensure that CCFL backlight usage information will always be associated with the panel, even when the panel is removed from the system. Those of skill in the art will understand that many such embodiments and variations of the invention are possible, including but not limited to those described hereinabove, which are by no means all inclusive.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a block diagram of an information handling system that can be used to implement the method and apparatus of the present invention;

FIG. 2 is a block diagram illustration of an embodiment of the invention as implemented on a Power Inverter Controller;

FIG. 3 is a block diagram illustration of an embodiment of the invention as implemented on a LCD Timing Controller;

FIG. 4 is a graphical illustration of a typical CCFL lifetime luminance curve for a predetermined current draw at a predetermined temperature; and

FIG. 5 is a graphical illustration of the relationship of a CCFL lifetime accelerator coefficient to operational environment temperature.

### DETAILED DESCRIPTION

The information handling system backlight usage monitor of the present invention measures and provides LCD panel backlight (e.g., cold cathode fluorescent lamp, or “CCFL”) usage data that can be correlated with vendor-specified lifetime curves to determine its remaining life. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

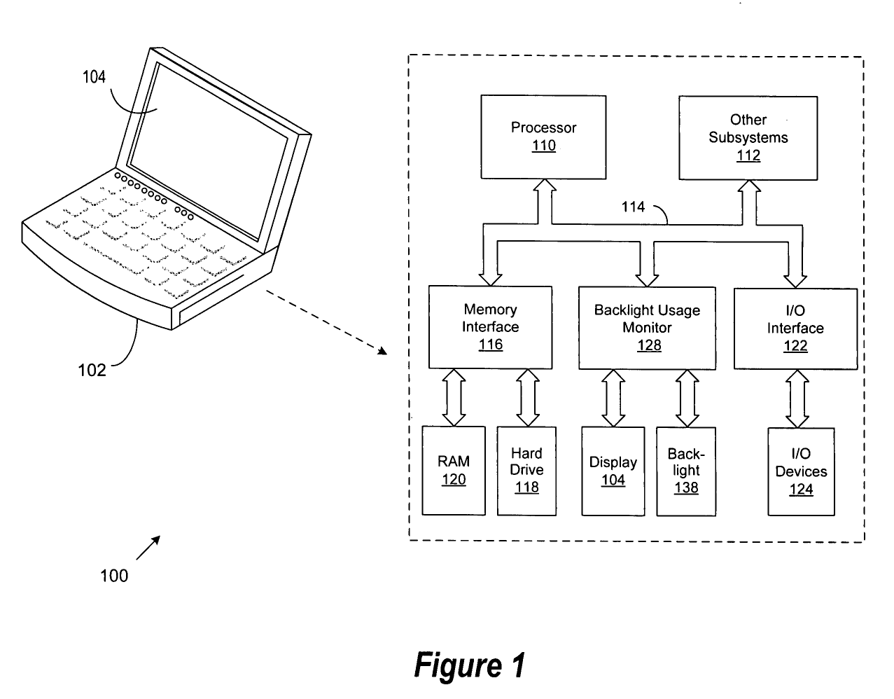

Referring now to FIG. 1, a block diagram depicts an information handling system 100 configured as a portable system having a plurality of processing components disposed in a housing 102. The functional components of the information handling system include a processor 110 and various other subsystems 112 understood by those skilled in the art. Data is transferred between the various system components via various data buses illustrated generally by bus 114. A memory interface 116 is operable to control data stored in various memory devices including a hard drive 118 and RAM 120. An input/output (I/O) interface 122 controls the transfer of data between the various system components and a plurality of input/output (I/O) devices 124 that may be attached to the information handling system via a plurality of I/O ports known to those of skill in the art. A backlight usage monitor system 128, described in greater detail below, is operable to measure and report LCD backlight 138 usage data (e.g., amount of time in operation, or “on”) as it relates to display 104.

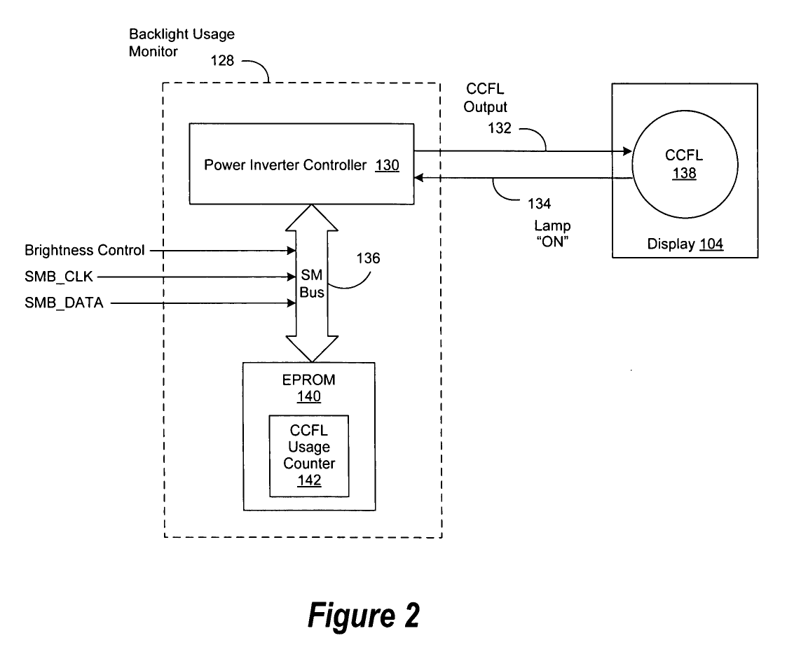

FIG. 2 is a block diagram illustration of functional components of backlight usage monitor system 128, for measuring and reporting CCFL 138 usage data as it relates to display 104. In an embodiment of the invention, backlight usage monitor system 128 is broadly comprised of power inverter controller 130, EPROM 140, CCFL usage counter 412, and System Management Bus (SMBUS) 136. Those of skill in the art will be familiar with SMBUS, generally used in personal computers and servers for low-speed system management communications. Advancements in the capabilities of power inverters typically used in conjunction with LCD panels allow for the implementation of an integrated counter and SMBUS register to store the length of time a CCFL has been in operation. In one embodiment of the invention, the algorithm used to measure CCFL usage is based on a simple measurement of the amount of time a CCFL has had power applied to it. In other embodiments of the invention, the algorithm used to measure CCFL usage is based on additional factors affecting CCFL lifetimes.

In an embodiment of the invention, system lifetime indicator 128 is implemented as a feature of a Built In Self Test (BIST) of the LCD panel, thereby providing a system diagnostics test capable of reading the amount of time the CCFL has been “on.” Such a test provides additional metrics for technical support and service personnel in determining the root cause of reported panel failures such as “dim video” or “no backlight.” To take full advantage of this feature, a reset function can be implemented to reset the SMBUS register to zero hours if the CCFL in the panel is replaced.

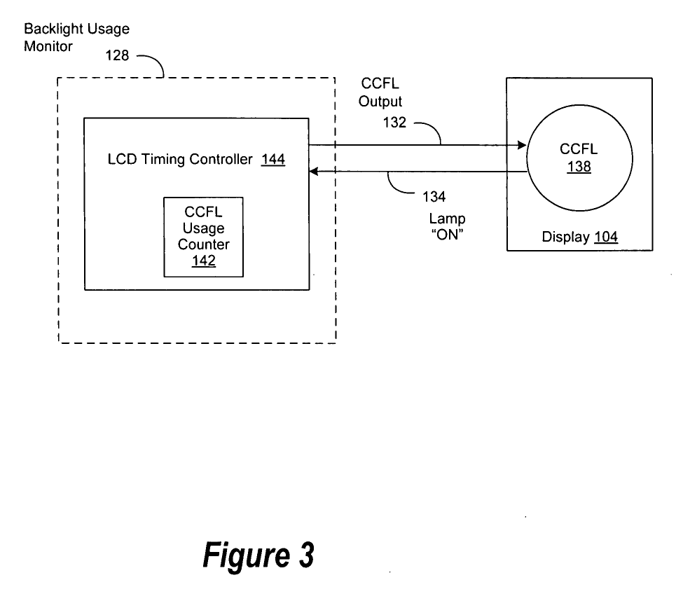

FIG. 3 is a block diagram illustration of functional components of backlight usage monitor system 128, for measuring and reporting CCFL 138 usage data as it relates to display 104. In an embodiment of the invention, backlight usage monitor system 128 is broadly comprised of CCFL usage counter 142 implemented on LCD Timing Controller (TCON) 130. In this embodiment of the invention, lamp usage information is be stored within the LCD Timing Controller (TCON).

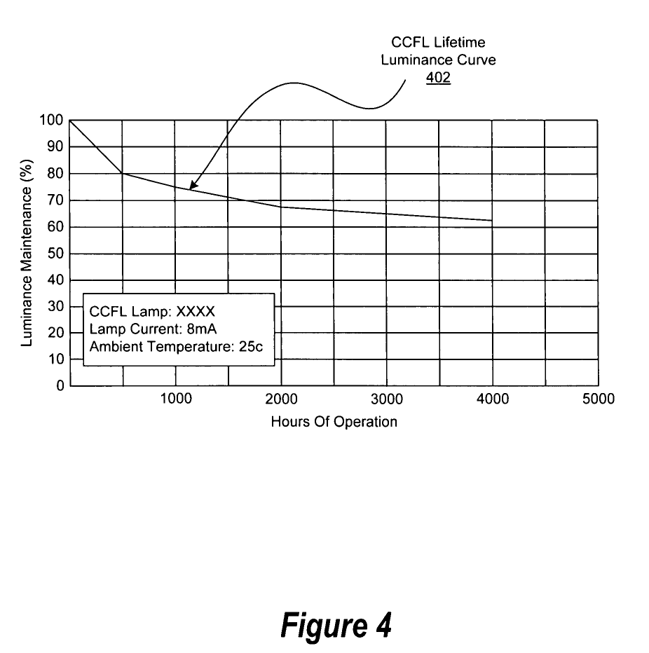

FIG. 4 is a graphical illustration of a typical CCFL lifetime luminance curve 402 for a predetermined current draw (e.g., 8 mA) at a predetermined temperature (e.g., 25 degrees Celsius). Skilled practitioners of the art will be aware that a CCFL's luminance generally decreases over its lifetime. The rate of this decrease can be dependent upon factors such as temperature, current draw, and other operational factors (e.g., burst mode duty cycles).

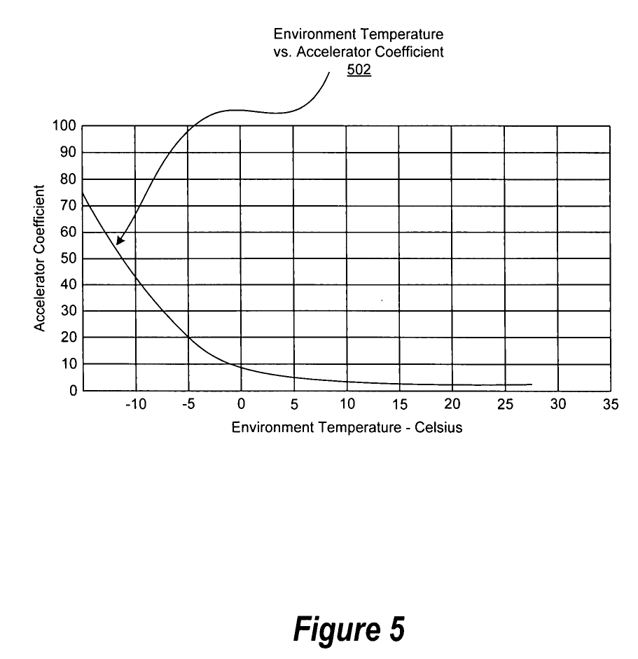

FIG. 5 is a graphical illustration of an accelerator coefficient vs. operational environment temperature curve 502 as it relates to CCFL lifetime acceleration. In this illustration, as environment temperature decreases, the CCFL lifetime accelerator coefficient increases. The actual hours of lamp usage multiplied by an acceleration factor are used to calculate the effective number of lamp hours of usage, i.e., actual hours on*acceleration factor=effective “time on” hours.

In various embodiments of the invention, additional CCFL usage factors such as burst mode duty cycles are used to obtain an acceleration factor for determining remaining lamp life. In this example, factors reducing lamp lifetime, such as operating the lamp in cold temperatures, have an acceleration factor greater than 1 and factors increasing lamp lifetime, such as operation in burst mode dimming have an acceleration factor less than 1. In various embodiments of the invention, these acceleration factors are automatically stored on the backlight usage monitor system 128.

In other embodiments of the invention, actual performance of a CCFL backlight under different operating conditions are correlated with a manufacturer's specifications, thereby making it possible to determine the effective time the lamp has been “on,” and measuring the brightness output of a panel. These correlations can be used to assist in identifying suppliers whose products consistently exceed specifications, thereby providing an ability to designate specific CCFL backlights for applications requiring longer lifetimes.

Although the present invention has been described in detail, it should be understood that various changes, substitutions and alterations can be made hereto without departing from the spirit and scope of the invention as defined by the appended claims.

What is claimed is:

1. An information handling system comprising:
data processing components operable to generate visual information;
a display operable to present the visual information;
a backlight operable to provide a light source for said display; and
a backlight usage monitor operable to store data correlatable with the usage of said backlight.

2. The information handling system of claim 1, wherein said display is coupled to an inverter and said backlight usage monitor is integrated with said inverter.

3. The information handling system of claim 2, wherein said backlight usage monitor is operable to measure usage based on the number of actual hours said backlight is turned on.

4. The information handling system of claim 2, wherein said backlight usage monitor is operable to measure usage based on an acceleration factor used to measure the effective usage time of said backlight.

5. The information handling system of claim 4, wherein said acceleration factor calculated using the environmental temperature in which said backlight is operated.

6. The information handling system of claim 4, wherein said acceleration factor is calculated using burst mode dimming information.

7. The information handling system of claim 4, wherein said effective usage time is stored in a display timing controller used to control operation of said display.

8. A method for measuring usage of a display, comprising:
using a display to present visual information, said display comprising a backlight operable to provide a light source for said display; and
using a backlight usage monitor to store data correlatable with the usage of said backlight.

9. The method of claim 8, wherein said display is controlled by an inverter and said backlight usage monitor is integrated with said inverter.

10. The method of claim 9, wherein said backlight usage monitor is operable to measure usage based on the number of actual hours said backlight is turned on.

11. The method of claim 9, wherein said backlight usage monitor is operable to measure usage based on an acceleration factor used to measure the effective usage time of said backlight.

12. The method of claim 11, wherein said acceleration factor is calculated using the environmental temperature in which said backlight is operated.

13. The method of claim 11, wherein said acceleration factor is calculated using burst mode dimming information.

14. The method of claim 13, wherein said acceleration factors are stored in said backlight usage monitor.

15. The method of claim 11, wherein said effective usage time is stored in a display timing controller used to control operation of said display.

16. A system for measuring usage of a display operable to present visual information, comprising:
a cold cathode fluorescent lamp (CCFL) operable to provide a light source for said display; and
a cold cathode fluorescent lamp usage monitor operable to store data correlatable with the usage of said cold cathode fluorescent lamp.

17. The system of claim 16, wherein said display is controlled by an inverter and said cold cathode fluorescent lamp usage monitor is integrated with said inverter.

18. The system of claim 17, wherein said cold cathode fluorescent lamp usage monitor is operable to measure usage based on the number of actual hours said cold cathode fluorescent lamp is turned on.

19. The system of claim 17, wherein said cold cathode fluorescent lamp usage monitor is operable to measure usage based on an acceleration factor used to measure the effective usage time of said cold cathode fluorescent lamp.

20. The system of claim 19, wherein said acceleration factor calculated using the environmental temperature in which said cold cathode fluorescent lamp is operated.
